(19) United States
(12) Patent Application Publication
(10) Pub. No.: US 2013/0239566 A1
(43) Pub. Date: Sep. 19, 2013

(54) INTEGRATED ELECTRONIC HYDRAULIC BRAKE SYSTEM

(71) Applicants: Hyun Jun KIM, Suwon-si (KR); I Jin Yang, Seongnam-si (KR); Seong Ho Choi, Anyang-si (KR)

(72) Inventors: Hyun Jun KIM, Suwon-si (KR); I Jin Yang, Seongnam-si (KR); Seong Ho Choi, Anyang-si (KR)

(21) Appl. No.: 13/797,565

(22) Filed: Mar. 12, 2013

(30) Foreign Application Priority Data
Mar. 13, 2012 (KR) 10-2012-0025409

(51) Int. Cl. B60T 13/14

(52) U.S. Cl. CPC B60T 13/142
USPC 60/534

(57) ABSTRACT

An integrated electronic hydraulic brake system provided with an actuator including a master cylinder and a pedal simulator, an electronic stability control (ESC) and a hydraulic power unit (HPU) in a single unit.

### CROSS-REFERENCE TO RELATED APPLICATION

This application claims the benefit of Korean Patent Application No. 2012-0025409, filed on Mar. 13, 2012 in the Korean Intellectual Property Office, the disclosure of which is incorporated herein by reference.

### BACKGROUND

1. Field

Embodiments of the present invention relate to an electronic hydraulic brake system, and more particularly, to an integrated electronic hydraulic brake system which is provided with an actuator, having a master cylinder and a pedal simulator, an electronic stability control (ESC) and a hydraulic power unit (HPU) in a single unit.

2. Description of the Related Art

In recent years, for the fuel efficiency and exhaust gas reduction, hybrid vehicles, fuel cell vehicles, and electric vehicles have been actively developed. Such a vehicle needs to be provided with a brake apparatus, that is, a brake apparatus of a brake system for vehicles. The brake apparatus for vehicle represents an apparatus configured to reduce the vehicle speed or to stop the vehicle while on the driving of a vehicle.

In general, the brake apparatus includes a vacuum brake generating a brake force by use of the suction pressure of an engine and a hydraulic brake generating a brake force by use of the hydraulic pressure.

The vacuum brake represents an apparatus that exhibits a large brake force by use of the pressure difference between the suction pressure of the vehicle engine and the atmospheric pressure at a vacuum booster. That is, when a driver steps a pedal, the vacuum brake generates an output significantly greater than the force applied to the pedal by a driver.

In order for the vacuum brake to form vacuum, a suction pressure of the engine of the vehicle needs to be provided to a vacuum booster, causing the fuel efficiency to be reduced. In addition, in order to form vacuum at the time of stopping the vehicle, the engine needs to be driven at all times.

In addition, since the fuel cell vehicle and the electric vehicle are not provided with engines, the general vacuum brake that amplifies the pedal effort between the brake operations is difficult to be applied to the fuel cell vehicle and the electric vehicle, and since the hybrid vehicle needs to be equipped with an idle stop function to enhance the fuel efficiency, the hydraulic brake is required.

That is, all the vehicles described above needs to implement the regenerative brake operation to enhance the fuel efficiency, and the hydraulic brake easily enables the regenerative braking operation.

Meanwhile, an electronic hydraulic brake system classified into the hydraulic brake is a brake system in which a driver steps a pedal and an electronic control unit senses the stepping on the pedal and supplies a fluid pressure to a master cylinder, and thus the brake fluid pressure to wheel cylinders (not shown) on respective wheels so as to generate a brake force.

Referring to FIG. 1, the electronic hydraulic brake system includes an actuator 1 including a master cylinder 1a to control the brake fluid pressure being delivered to a wheel cylinder 20, a booster 1b, a reservoir 1c and a pedal simulator 1d, an electronic stability control (ESC) 2 individually controlling the respective wheels, and a hydraulic power unit (HPU) 3 including a motor, a pump, an accumulator and a control valve.

However, the respective units forming the electronic hydraulic brake system are separately provided and installed from each other, a large installation space needs to be ensured due to the limitation on the installation space in the vehicle, and also the weight of the vehicle is increased. In this regard, there is a need for an electronic hydraulic brake system capable of ensuring the vehicle stability at the braking operation, enhancing the fuel efficiency and the proper stepping operation while improving the braking performance.

In addition, the pedal simulator 1d is an apparatus that receives a pressure generated by the food effort of a brake pedal (not shown) to press a piston (not shown) and a spring (not shown) that are provided at an inside a simulation chamber (not shown) so as to provide a stepping operation according to the reaction to the compression of the spring. Such a conventional pedal simulator 1d is provided as a dry type. The dry type is implemented as a pneumatic structure including a simulation chamber having a piston and a spring exposed to the air. Accordingly, the movement of piston causes a friction and a long period of time of use of the pedal simulator reduces the durability and increases the possibility for foreign substance to be introduced.

Accordingly, a large amount of researches is conducted to develop an electronic hydraulic brake system provided with a simple configuration, ensuring an easy control, facilitating implementing a brake force even at a malfunction, improving the durability of a pedal simulator and preventing foreign substances from being introduced.

### SUMMARY

Therefore, it is an aspect of the present invention to provide an integrated electronic hydraulic brake system having a simple configuration thereof so as to improve the safety on the braking operation and the installation efficiency on the vehicle, and during the brake operation, providing a stable stepping action while enhancing the fuel efficiency by supporting the regenerative brake.

Additional aspects of the invention will be set forth in part in the description which follows and, in part, will be obvious from the description, or may be learned by practice of the invention.

In accordance with one aspect of the present invention, an integrated electronic hydraulic brake system for vehicles includes a master cylinder, a reservoir, two hydraulic circuits, an accumulator, a pump, a motor, a flow control valve and a pressure reducing valve, a balance valve, a first shut off valve and a second shut off valve, a pedal simulator and a simulation valve. The master cylinder may be configured to generate a fluid pressure according to a pedal effort of a brake pedal. The reservoir may be coupled to an upper part of the master cylinder so as to store oil. The two hydraulic circuits each may be connected to two wheels. The accumulator may be configured to store a predetermined level of pressure. The pump may be configured to draw the oil through a hydraulic pipe connected to the reservoir and discharge the drawn oil to the accumulator to form a pressure at the accumulator. The motor may be configured to drive the pump. The flow control valve and a pressure reducing valve may be connected to one of the two hydraulic circuits so as to control a pressure being transmitted from the accumulator to wheel cylinders installed on the respective wheels. The balance valve may be provided between the two hydraulic circuits to control a connection between the two hydraulic circuits. The first shut off valve and the second shut off valve may be installed between the master cylinder and the two hydraulic circuits to block a fluid pressure according to a pedal effort of a driver. The pedal simulator may be connected to the master cylinder to provide a reaction force of the brake pedal. The simulation valve may be installed at a rear end of the pedal simulator. The simulation valve may be connected to the reservoir such that oil is filled into an inside the pedal simulator through the simulation valve.

Each of the flow control valve and the pressure reducing valve may be provided as a single high capacity valve serving as a normally close type solenoid valve that is maintained in a closed state at normal times.

The balance valve may be a normally close type solenoid valve that is maintained in a closed state at normal times, and during a brake operation, may be open based on pressure information.

The integrated electronic hydraulic brake system for vehicles may further include a simulation check valve. The simulation check valve may be provided between the pedal simulator and the simulation valve, wherein a pressure at a rear end of the simulation valve according to the pedal effort of the brake pedal may be transmitted only through the simulation valve, and at the time of releasing of the pedal effort of the brake pedal, oil may be drawn through the simulation check valve and stored in the pedal simulator.

The simulation check valve may be provided as a pipe-purpose check valve having no spring such that a residual pressure of the pedal simulator may be returned at the time of releasing the pedal effort of the brake pedal.

Each of the hydraulic circuits may include a normally open type solenoid valve, a normally closed type solenoid valve and a return path. The normally open type solenoid valve may be disposed at a upstream side of the wheel cylinder to control a fluid pressure being transmitted to the wheel cylinder. The normally closed type solenoid valve may be disposed at a downstream side of the wheel cylinder to control a fluid pressure being discharged from the wheel cylinder. The return path may connect the normally closed type solenoid valve to the hydraulic pipe.

Each of the first shut off valve and the second shut off valve may be provided as a normally open type solenoid valve that is maintained in an open state at normal times, and at the time of a normal braking, may be operated to be closed.

A pulsation attenuation device configured to minimize a pressure pulsation may be formed on a path connecting the fluid control valve and the pressure reducing valve to one of the two hydraulic circuits.

As described above, the integrated electronic hydraulic brake system in accordance with the present disclosure is provided with an actuator including a master cylinder and a pedal simulator, and various valves and sensors serving as an electronic stability control (ESC) and a hydraulic power unit (HPU) in a single block, thereby easily securing the installation space and decreasing the weight thereof while facilitating the assembly process.

In addition, in order to supply or release pressure with respect to two hydraulic circuits, two hydraulic circuits are connected using a balance valve, and the pressure is controlled through a single flow control valve and a single pressure reducing valve, thereby facilitating the control of pressure while improving the control characteristics.

In addition, a pedal simulator is connected to a reservoir, and a simulation valve is provided to control the connection between the pedal simulator and the reservoir, so that oil is stored in the pedal simulator and the durability of the pedal simulator is improved while preventing the foreign substances from being introduced.

In addition, a simulation check valve having no spring is provided, so that the residual pressure is minimized, and even if the pressure is randomly adjusted during the brake operation, the pedal operation being delivered to the driver is stably maintained.

In addition, the brake operation is performed even at the malfunction of the brake system, so that the application to the electric vehicles, fuel cell vehicles and hybrid vehicles is easily achieved.

In addition, regardless of the existence or the operation of an engine, a brake force desired by a driver is implemented, so that the fuel efficiency is enhanced.

In addition, when compared to a conventional negative pressure type booster, the integrated electronic hydraulic brake system in accordance of the present disclosure has a simple configuration, and different from a vacuum brake, the suction pressure of the engine is not used, so that the fuel efficiency of the vehicles is enhanced. In addition, such a simple configuration of the electronic hydraulic brake system enables the application to a compact size vehicle.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view schematically illustrating a conventional electronic hydraulic brake system;

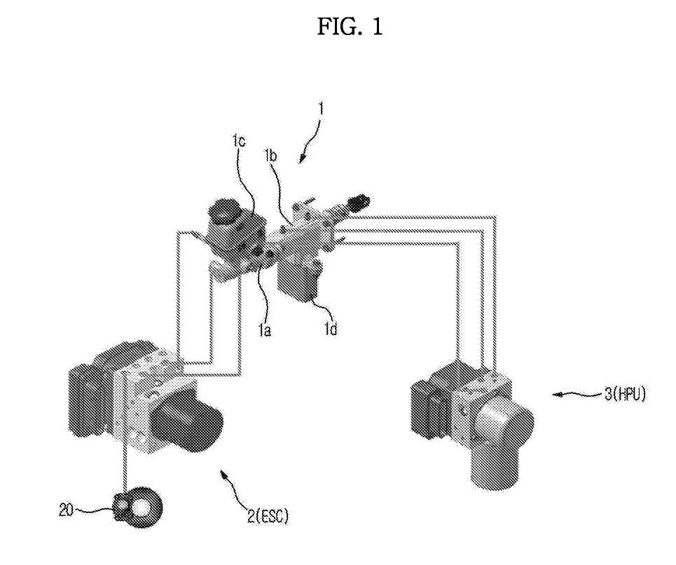

FIG. 2 is a hydraulic circuit diagram of an integrated electronic hydraulic brake system in accordance with one embodiment of the present disclosure at a non-braking operation;

FIG. 3 is a hydraulic circuit diagram of an integrated electronic hydraulic brake system in accordance with one embodiment of the present disclosure at a normal operation; and

FIG. 4 is a hydraulic circuit diagram of an integrated electronic hydraulic brake system in accordance with one embodiment of the present disclosure at an abnormal operation.

### DETAILED DESCRIPTION

Reference will now be made in detail to the embodiments of the present invention, examples of which are illustrated in the accompanying drawings, wherein like reference numerals refer to like elements throughout.

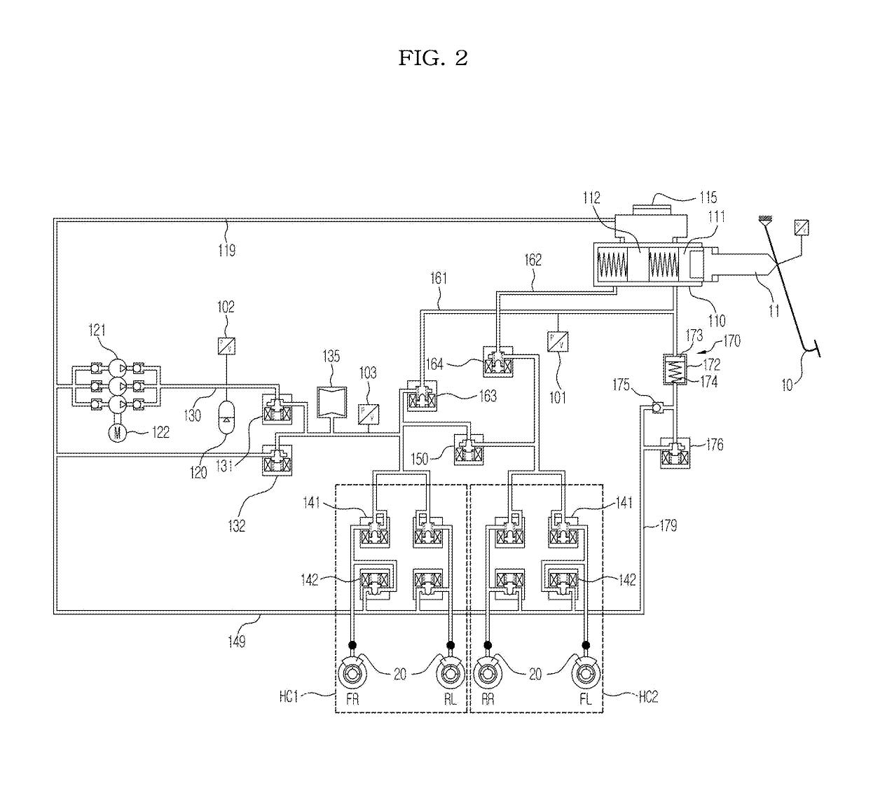

FIG. 2 is a hydraulic circuit diagram of an integrated electronic hydraulic brake system in accordance with one embodiment of the present disclosure.

Referring to FIG. 2, the integrated electronic hydraulic brake system includes a brake pedal 10 manipulated by a driver at a braking operation, a master cylinder 110 to which the force is transmitted from the brake pedal 10, a reservoir 115 coupled to an upper part of the master cylinder 110 so as to store oil, two hydraulic circuits HC1 and HC2 each connected to two of wheels RR, RL, RF and FL, an accumulator 120 to store a predetermined level of pressure, a pump 121 to draw the oil through a hydraulic pipe 119 connected to the reservoir 115 and discharge the drawn oil to the accumulator 120 to form a pressure at the accumulator 120, a motor 122 to drive the pump 121, a flow control valve 131 and a pressure reducing valve 132 that are connected to one of the two hydraulic circuits HC1 and HC2 so as to control a pressure being transmitted from the accumulator 120 to wheel cylinders 20 installed on the respective wheels FL, FR, RL and RR, a balance valve 150 provided between the two hydraulic circuits HC1 and HC2 to control a connection between the two hydraulic circuits HC1 and HC2, a first shut off valve 163 and a second shut off valve 164 installed between the master cylinder 110 and the two hydraulic circuits HC1 and HC2 to block the fluid pressure according to the pedal effort of a driver, a pedal simulator 170 connected to the master cylinder 110 to provide a reaction force of the brake pedal, and a simulation valve 176 installed on an oil path 179 connecting the pedal simulator 170 to the reservoir 115.

In addition, the integrated electronic hydraulic brake system may further include pressure sensors 101, 102, and 103 disposed at a designated position on a path forming the system so as to measure the pressure generated during the brake operation.

The master cylinder 110, the reservoir 115, and the pedal simulator 170 are grouped in a single entity into which the functionalities of the ESC and HPU are incorporated, so that the weight of the integrated electronic hydraulic brake system in accordance with the present disclosure is reduced and the installation space is secured.

Hereinafter, the configuration and the function of each component forming the integrated electronic hydraulic brake system will be described in detail. First, the master cylinder 110 may be formed by at least one chamber to generate a fluid pressure, and is illustrated as being formed by two chambers in which a first piston 111 and a second piston 112 are formed, respectively. The master cylinder 110 is configured to generate a fluid pressure according to the pedal effort of the brake pedal 10, and the chambers are connected to the two hydraulic circuits HC1 and HC2, respectively. The master cylinder 110 is provided at an upper side with the reservoir 115 in which oil is filled, and at a lower side with an exit allowing oil to be discharged to the wheel cylinder 20, which is installed on each of the wheels RR, RL, FR, and FL, through a first backup path 161 and a second backup path 162.

Since the master cylinder 110 is provided with the two chambers which are connected to the two hydraulic circuits HC1 and HC2, the operation safety is secured at a malfunction. For example, as shown on the drawing, a first hydraulic circuit HC1 between the two hydraulic circuits HC1 and HC2 is connected to a front right wheel FR and a rear left wheel RL and a second hydraulic circuit HC2 between the two hydraulic circuits HC1 and HC2 is connected to a front left wheel FL and a rear right RR. Alternatively, a first hydraulic circuit HC1 between the two hydraulic circuits HC1 and HC2 may be connected to two front wheels FL and FR and a second hydraulic circuit HC2 between the two hydraulic circuits HC1 and HC2 may be connected to two rear wheels RL and RR. As described, the two hydraulic circuits HC1 and HC2 are configured independent of each other, and even if one of the hydraulic circuits HC1 and HC2 is broken, the braking operation for vehicles may be possible.

Meanwhile, each of the hydraulic circuits HC1 and HC2 includes a path connecting to the wheel cylinder 20, and a plurality of valves 141 and 142 is provided on the path to control the fluid pressure. As shown on the drawing, the plurality of valves 141 and 142 is divided into a normally open type (hereinafter, referred to as a NO type) solenoid valve 141 disposed at an upstream side of the wheel cylinder 20 to control the fluid pressure being transmitted to the wheel cylinder, and a normally closed type (hereinafter, referred to as a NC type) solenoid valve 142 disposed at a downstream side of the wheel cylinder 20 to control the fluid pressure being discharged from the wheel cylinder 20. The opening/closing operation of the solenoid valves 141 and 142 is controlled by an electronic control unit (not shown) that is generally known in the art.

In addition, each of the hydraulic circuits HC1 and HC2 includes a return path 149 connecting the NC type solenoid valve 142 to the hydraulic pipe 119. The return path 149 is connected to the hydraulic pipe 119 and an oil path 179, which is to be described later. The return path 149 is configured to discharge the fluid pressure being transmitted to the wheel cylinder 20 such that the fluid pressure is transmitted to the reservoir 115 or is transmitted to the accumulator 120 through pumping of the pump 121.

The balance valve 150 is installed between the two hydraulic circuits HC1 and HC2 to control the connection between the two hydraulic circuits HC1 and HC2. The balance valve 150 is provided as a normally close type solenoid valve that is maintained in a closed state at normal times and is open based on pressure information. The balance valve 150 connects the two hydraulic circuits HC1 and HC2 to each other such that fluid pressure is supplied to the wheel cylinder 20 provided on each of the hydraulic circuits HC1 and HC2. Detailed description of the balance valve 150 will be described later.

Meanwhile, reference numeral ‘11’ represents an input load installed on the brake pedal 10 so as to transmit a pedal effort to the master cylinder 110.

The pump 121 is provided in at least one unit thereof so as to pump the oil being introduced from the reservoir 115 at high pressure, thereby forming a brake pressure. The motor 122 is provided at one side of the pump 121 to provide the pump 121 with a driving force. The motor 122 is driven by receiving the desire of a driver for a braking operation according to the pedal effort from a first pressure sensor 101 or a pedal displacement sensor that is to be described later.

The accumulator 120 is provided at an exit side of the pump 121 to temporarily store oil of a high pressure that is generated by the pump 210 driven. As described above, the accumulator 120 is disposed on a connection path 130 connecting the pump 121 to the flow control valve 131 to temporarily store the high pressure oil being discharged from the pump 121. Although not shown, a check valve is installed between the pump 121 and the accumulator 120 to prevent the oil stored in the accumulator 120 from being flown backward.

A second pressure sensor 102 is provided at an exit side of the accumulator 120 to measure the oil pressure of the accumulator 120. In this case, the oil pressure measured by the second pressure sensor 102 is compared with a predetermined pressure that is set by the electronic control unit (not shown), and the pump 121 is driven if the measured oil pressure is lower than the predetermined oil pressure, so that the oil in the reservoir 115 is drawn to be filled in the accumulator 120.

In order to transmit the brake oil stored in the accumulator 120 by the operation of the pump 121 and motor 122 to the wheel cylinder 20, the connection path 130 connected to one of the hydraulic circuits HC1 and HC2 is provided. On the drawing, the connection path 130 is illustrated as being connected to the first hydraulic circuit HC1. In addition, the flow control valve 131 and the pressure reducing valve 132 are provided on the connection path 130 so as to control the brake oil stored in the accumulator 120.

Each of the flow control valve 131 and the pressure reducing valve 132 is provided as a normally close type solenoid valve that is maintained in a closed state at normal times. Accordingly, if a drives steps the brake pedal 10, the flow control valve 131 is open, and then the brake oil stored in the accumulator 120 is transmitted to the wheel cylinder 20. In this case, the brake oil being transmitted through the flow control valve 131 is transmitted to the first hydraulic circuit HC1 connected to the connection path 130, and at this time, the balance valve 150 connecting the two hydraulic circuits HC1 and HC2 to each other is operated to be open, so that the brake oil is transmitted to the second hydraulic circuit HC2. That is, the brake oil of the accumulator 120 is transmitted to each wheel cylinder 20 as the flow control valve 130 and the balance valve 150 are open.

Each of the flow control valve 131 and the pressure reducing valve 132 is provided in the form of a single valve configured to supply brake fluid pressure, and thus is provided as a high capacity valve. Although each of the flow control valve 131 and the pressure reducing valve 132 is illustrated as being provided in the form of a single valve, the present disclosure is not limited thereto. If a capacity is insufficient, each of the flow control valve 131 and the pressure reducing valve 132 may be provided in the form of a combination of two or more valves.

Meanwhile, a pulsation attenuation device 135 is installed on the connection path 130 connecting the flow control valve 131 to the first hydraulic circuit HC1 to minimize the pressure pulsation. The pulsation attenuation device 135 is designed to temporarily store oil so as to attenuate the pulsation generated among the flow control valve 131, the pressure reducing valve 132 and the NO type solenoid valve 141. The pulsation attenuation device is generally known in the art, and thus the detailed description thereof will be omitted.

In addition, a third pressure sensor 103 is provided on the connection path 130 to sense the pressure being transmitted to the hydraulic circuit HC1. Accordingly, the pulsation attenuation device 135 is controlled to lower the pulsation according to the pressure of the brake oil being sensed by the third pressure sensor 103.

In accordance with the present disclosure, a first backup path 161 and a second backup path 162 are provided that connect the master cylinder 110 to the two hydraulic circuits HC1 and HC2 when the integrated electronic hydraulic brake system is broken. A first shut off valve 163 is provided on the first backup path 161 to block the pressure of the master cylinder 110 according to the pedal effort of the driver, and a second shut off valve 164 is provided on the second backup path 162 to block the pressure of the master cylinder 110 according to the pedal effort of the driver. Each of the first and second shut off valves 163 and 164 is provided as a NO type solenoid valve that is maintained in an open state at normal times, and during a normal braking operation, is closed. The first backup path 161 is connected to the first hydraulic circuit HC1 and the connection path 130 through the first shut off valve 163, and the second backup path 162 is connected to the second hydraulic circuit HC2 through the second shut off valve 164. In particular, the first pressure sensor 101 is provided on the first backup path 161 to measure the oil pressure of the master cylinder 110. Through such, at a normal braking operation, the backup paths 161 and 162 are blocked by the first shut off valve 163 and the second shut off valve 164 and the desire of the driver for brake operation is determined by the first pressure sensor 101, and at an abnormal braking operation, the first shut off valve 163 and the second shut off valve 164 are in an open state, so the brake pressure generated from the master cylinder 110 is directly transmitted to the wheel cylinder 20.

In accordance with the present disclosure, the pedal simulator 170 is provided between the first pressure sensor 101 and the master cylinder 110 to form a pedal effort of the brake pedal 10.

The pedal simulator 170 includes a simulation chamber 172 provided to store oil being discharged from the exit side of the master cylinder 110, and the simulation valve 176 connected to a rear end of the simulation chamber 172. The simulation chamber 172 includes a piston 173 and an elastic member 174 so as to form a predetermined range of displacement by the oil being introduced to the simulation chamber 172.

The simulation valve 176 is installed on the oil path 179 connecting the rear end of the pedal simulator 170 to the reservoir 115. In this case, the oil path 179 is connected to the reservoir 115 while being connected to the return path 149. As shown on the drawing, an entry of the pedal simulator 170 is connected to the master cylinder 110, the simulator valve 176 is mounted at the rear end of the pedal simulator 170 and an exit of the simulation valve 176 is connected to the return path 149, which is connected to the reservoir 115, through the oil path 179 so that pedal simulator 170, that is, the interior space of the simulation chamber 172 is fully filled with oil.

The simulation valve 176 is provided in the form of a normally close type that is maintained in a closed state at normal times, and when a driver steps the brake pedal 10, the simulation valve 176 is operated to be open.

In addition, a simulation check valve 175 is provided between the pedal simulator 170 and the master cylinder 110, that is, between the pedal simulator 170 and the simulation valve 176, and the simulation check valve 175 is configured to allow the oil to flow from the reservoir 115 to the simulation chamber 172. The simulation check valve 175 is configured to allow the pressure at the rear end of the pedal simulator 170 according to the pedal effort of the brake pedal 10 to be transmitted only through the simulation valve 176. That is, the piston 173 of the pedal simulator 170 compresses the spring 174, and the oil in the simulation chamber 172 is transmitted to the reservoir 115 through the simulation valve 176 and the oil path 179. At this time, oil is filled in the simulation chamber 172, so the friction of the piston 173 is minimized during the operation of the pedal simulator 170, and the durability of the pedal simulator 170 is improved, thereby providing a structure preventing the foreign substance from being introduced thereinto.

In addition, at the time of releasing the pedal effort of the brake pedal 10, oil is supplied to the simulation chamber 172 through the simulation check valve 175, and thus the return of the pressure of the pedal simulator 170 is achieved in a rapid manner. The simulation check valve 175 may be provided as a pipe-purpose check valve having no spring, so that the residual pressure of the pedal simulator 170 is returned at the time of releasing the pedal effort of the brake pedal 10.

The integrated electronic hydraulic brake system is provided as a single block including an electronic control unit (ECU) that is electrically connected to the respective valves and sensors and control the valves and sensors, thereby leading to the compact structure. That is, the integrated electronic hydraulic brake system in accordance with the present disclosure is incorporated with the motor 122 and the pump 121 as well as the pedal simulator 170 configured to form a pedal effort of the brake pedal 10 in cooperation with the accumulator 120 and various valves and sensors in the form of a single block, thereby easily securing the installation space while decreasing the weight thereof.

Hereinafter, the operation of the integrated electronic hydraulic brake system in accordance with an embodiment of the present disclosure will be described in detail.

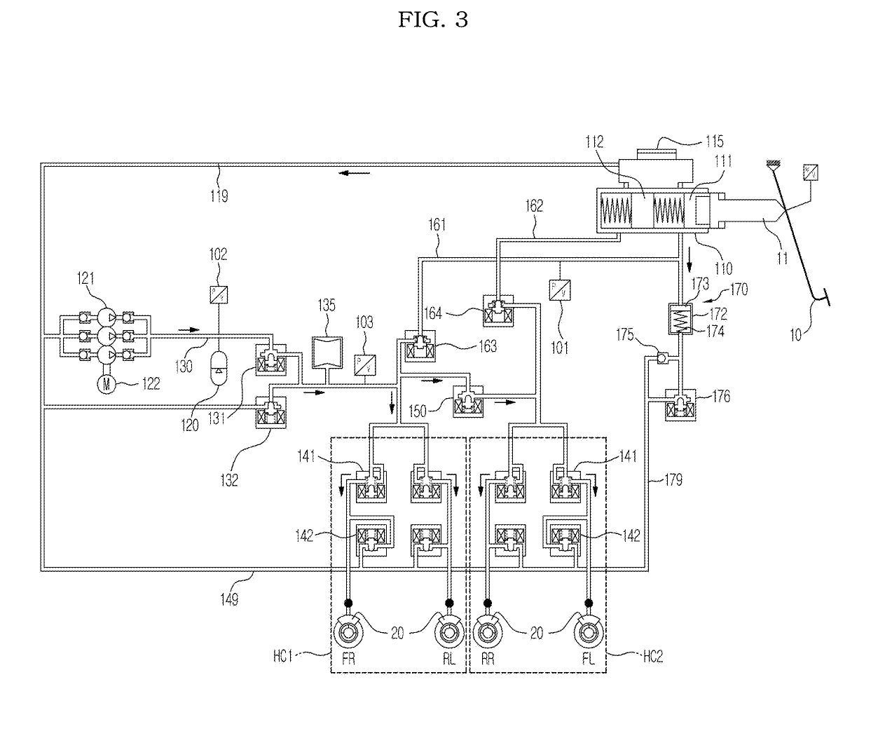

FIG. 3 is a hydraulic circuit diagram of an integrated electronic hydraulic brake system in accordance with one embodiment of the present disclosure at a normal operation.

Referring to FIG. 3, when a driver starts the brake operation, the amount of desired brake operation of a driver is sensed through the pressure information of the brake pedal 10 stepped by the driver, through the first pressure sensor 101 or a pedal displacement sensor. The electronic control unit (not shown) may receive the magnitude of the amount of regenerative brake, and the magnitude of the amount of friction brake is calculated according to the difference between the amount of desired brake operation and the amount of regenerative brake operation, thereby determining the magnitude of increase or decrease of pressure at the wheel side.

In detail, in the beginning of the braking operation, if a driver steps the brake pedal 10, the braking operation is sufficiently achieved by the regenerative brake, and thus a control is made to prevent the friction brake from occurring. Accordingly, a pressure reduction of brake oil is required so as to prevent the fluid pressure, which is generated at the master cylinder 110 after being transmitted from the brake pedal 10, from being transmitted to the wheel cylinder 20. In this case, by opening the pressure reducing valve 132 so that the fluid pressure formed at the connection path 130 is discharged to the reservoir 115 through the return path 149 so as to prevent pressure from being formed at the wheels RR, RL, FR, and FL while maintaining the pressure of the brake pedal.

Thereafter, a process of adjusting the amount of friction brake according to the change in the regenerative brake is performed. The amount of regenerative brake varies with the charging status of a battery or the vehicle speed. If the vehicle speed is below a predetermined speed, the amount of the regenerative brake is rapidly decreased. In order to cope with such a condition, the flow control valve 131 may control the flow rate of the brake oil being transmitted from the accumulator 120 to the connection path 130.

Thereafter, the amount of regenerative brake is not present, so the braking operation is performed according to a general brake condition.

Meanwhile, since the connection path 130 is connected only to the first hydraulic circuit HC1, the NC type balance valve 150 controlling the connection between the two hydraulic circuits HC1 and HC2 is operated to be open such that the pressure is transmitted to the two hydraulic circuits HC1 and HC2.

In addition, the pressure generated by the pressing of the master cylinder 110 according to the pedal effort of the brake pedal 10 is transmitted to the pedal simulator 170 connected to the master cylinder 110. In this case, the simulation valve 176 installed on the oil path 179 connecting the rear end of the pedal simulator 170 to the reservoir 115 is operated to be open, so that the oil filled in the simulation chamber 172 is transmitted to the reservoir 115 through the simulation valve 176. In addition, the pressure corresponding to the weights of the piston 173 and the spring 174 supporting the piston 173 may provide the driver with a proper stepping sensation through the simulation chamber 172. In addition, at the time of releasing the pedal effort of the brake pedal 10, the oil is refilled into the simulation chamber 172 through the simulation check valve 175, thereby ensuring the return of pressure of the pedal simulator 170 in a rapid manner.

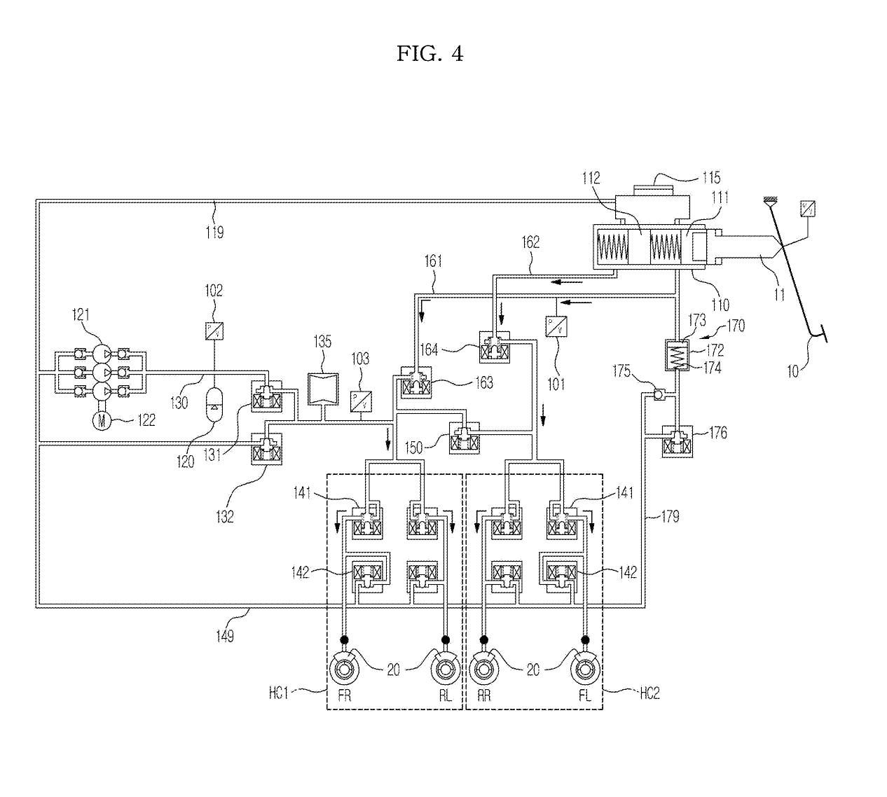

FIG. 4 is a hydraulic circuit diagram of an integrated electronic hydraulic brake system in accordance with one embodiment of the present disclosure at an abnormal operation.

Referring to FIG. 4, when the integrated electronic hydraulic brake system is not normally operated, the pressure is transmitted through the first backup path 161 and the second backup path 162 to the wheel cylinder 20, thereby implementing the brake force. In this case, each of the first shut off valve 163 and the second shut off valve 164, which are installed on the first backup path 161 and the second backup path 162, and the solenoid valve 141 of the two hydraulic circuits HC1 and HC2 is provided as a normally open type solenoid valve, and each of the flow control valve 131, the pressure reducing valve 132 and the balance valve 150 is provided as a normally close type solenoid valve, so that the fluid pressure is directly transmitted to the wheel cylinder 20. Accordingly, a stable braking is achieved, thereby improving the safety on the brake operation.

Meanwhile, the master cylinder 110 has a reduced inner circumference when compared to a general master cylinder so as to maximize the mechanical braking performance according to the pedal effort of the brake pedal 10. That is, the master cylinder 110 has an inner circumference smaller than that of a general master cylinder, but may exit a sufficient brake force through the brake oil stored in the reduced inner circumference.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An integrated electronic hydraulic brake system for vehicles comprising:
a master cylinder to generate a fluid pressure according to a pedal effort of a brake pedal;
a reservoir coupled to an upper part of the master cylinder so as to store oil;
two hydraulic circuits each connected to two wheels;
an accumulator to store a predetermined level of pressure;
a pump to draw the oil through a hydraulic pipe connected to the reservoir and discharge the drawn oil to the accumulator to form a pressure at the accumulator;
a motor to drive the pump;
a flow control valve and a pressure reducing valve that are connected to one of the two hydraulic circuits so as to control a pressure being transmitted from the accumulator to wheel cylinders installed on the respective wheels;
a balance valve provided between the two hydraulic circuits to control a connection between the two hydraulic circuits;
a first shut off valve and a second shut off valve installed between the master cylinder and the two hydraulic circuits to block a fluid pressure according to a pedal effort of a driver;
a pedal simulator connected to the master cylinder to provide a reaction force of the brake pedal; and
a simulation valve installed at a rear end of the pedal simulator,
wherein the simulation valve is connected to the reservoir such that oil is filled into an inside the pedal simulator through the simulation valve.

2. The integrated electronic hydraulic brake system for vehicles of claim 1, wherein each of the flow control valve and the pressure reducing valve is provided as a single high capacity valve serving as a normally close type solenoid valve that is maintained in a closed state at normal times.

3. The integrated electronic hydraulic brake system for vehicles of claim 1, wherein the balance valve is a normally close type solenoid valve that is maintained in a closed state at normal times, and during a brake operation, is open based on pressure information.

4. The integrated electronic hydraulic brake system for vehicles of claim 1, further comprising:
a simulation check valve provided between the pedal simulator and the simulation valve, wherein a pressure at a rear end of the simulation valve according to the pedal effort of the brake pedal is transmitted only through the simulation valve, and at the time of releasing of the pedal effort of the brake pedal, oil is drawn through the simulation check valve and stored in the pedal simulator.

5. The integrated electronic hydraulic brake system for vehicles of claim 4, wherein the simulation check valve is provided as a pipe-purpose check valve having no spring such that a residual pressure of the pedal simulator is returned at the time of releasing the pedal effort of the brake pedal.

6. The integrated electronic hydraulic brake system for vehicles of claim 1, wherein each of the hydraulic circuits comprises:
a normally open type solenoid valve disposed at a upstream side of the wheel cylinder to control a fluid pressure being transmitted to the wheel cylinder;
a normally closed type solenoid valve disposed at a downstream side of the wheel cylinder to control a fluid pressure being discharged from the wheel cylinder; and
a return path connecting the normally closed type solenoid valve to the hydraulic pipe.

7. The integrated electronic hydraulic brake system for vehicles of claim 1, wherein each of the first shut off valve and the second shut off valve is provided as a normally open type solenoid valve that is maintained in an open state at normal times, and at the time of a normal braking, is operated to be closed.

8. The integrated electronic hydraulic brake system for vehicles of claim 1, wherein a pulsation attenuation device configured to minimize a pressure pulsation is formed on a path connecting the fluid control valve and the pressure reducing valve to one of the two hydraulic circuits.
